(19) United States
(12) Patent Application Publication
(10) Pub. No.: US 2019/0214836 A1
(43) Pub. Date: Jul. 11, 2019

(54) WALL HOLDER FOR CHARGING CELL PHONES

(71) Applicants: ARMANDO GARCIA VIVEROS, RIO GRANDE CITY (MX); ANA KAREN BUSTOS SANCHEZ, RIO GRANDE CITY (MX)

(72) Inventors: ARMANDO GARCIA VIVEROS, RIO GRANDE CITY (MX); ANA KAREN BUSTOS SANCHEZ, RIO GRANDE CITY (MX)

(21) Appl. No.: 15/867,832

(22) Filed: Jan. 11, 2018

(51) Int. Cl. H02J 7/00

(52) U.S. Cl. CPC H02J 7/0044; H02J 2007/0062; H02J 7/0052

(57) ABSTRACT

A wall holder for charging cell phones that has a general U-shaped configuration comprising a first arm (1) and a second arm (3) facing each other, wherein the second arm (3) is also an arm that can be unfolded or detached at a distance thereof with respect to the first arm, said second arm (2) having a retractable horizontal latch (5) in the inner space of the mount through a slot (6), being able to select the position in which said second arm (2) is to be left at a distance thereof with respect to the first arm (1), wherein there are also connection plugs (8) to a power outlet in the rear face of the wall mount, said plugs (8) being placed on a rotatable mount (9) with respect to the rest of the mount, and it has a USB connector on one side. The holder makes it possible to not only secure any type of cell phone, but also be able to proceed to recharge the cell phone.

### OBJECT OF THE INVENTION

The object of the present invention, as established in the title, is a wall mount for charging cell phones that has the particular feature of being directly connected to an electrical power outlet.

The special configuration and design of the mount characterizes the present invention such that, on one hand, it is used as a means to hold or support a cell phone, and, on the other hand, the mount is directly connected to a power outlet and finally has the means necessary to proceed to recharge the battery of cell phones.

Therefore, the present invention falls within the field of so-called smart phones, and particularly within the field of accessories, mainly those dedicated to recharging cell phones.

### BACKGROUND OF THE INVENTION

When one wants to recharge the battery of cell phones in public spaces such as schools, airports, parks and similar, there are a number of associated problems, such as placement at uncontrolled heights, cables that have a limited length, or people who may carelessly toss or step on the cell phone.

Therefore, the object of the present invention is to develop a device that avoids the aforementioned problems by developing a wall mount for charging cell phones such as that described below and the essential nature of which is set out in the first claim.

### DESCRIPTION OF THE INVENTION

The object of the present invention is a wall mount for charging cell phones; in other words, a device that is used as a means to mount and hold cell phones that is directly anchored to the wall in electrical power outlets and that has the means necessary, such as a USB connector, to be able to proceed to recharge cell phones.

The wall mount has a general U-shaped configuration with the free ends slightly turned toward the inner space defined by the arms of the mount, wherein each of the arms has the particular feature of being able to move with respect to the rest of the mount, such that it makes it possible to adapt to the different dimensions that the cell phone may have.

Given its design and configuration, the mount can be used as a solid base for the consumption of entertainment or to refer to information without needing to hold it, such as, for example, referring to instructions or viewing a video while other tasks are carried out.

Furthermore, the mount may have integrated magnetic means in an inner space comprised between the two arms for the purpose of ensuring the hold of the cell phones on the wall mount.

Therefore, the object of the invention makes it possible to have a wall securing mount for cell phones in many ways, which furthermore makes it possible to recharge the phone while it is held by the mount, if necessary.

Except when indicated otherwise, all of the technical and scientific elements used in this specification have the meaning commonly understood by one with average skill in the art to which this invention belongs. When this invention is put into practice, methods and materials may be used that are similar or equivalent to the ones described in this specification.

Throughout the description and claims, the word “comprise” and its variants are not intended to exclude other technical characteristics, additions, components or steps. For those skilled in the art, other objects, advantages and characteristics of the invention may be deduced from both the description and the practical use of the invention.

### EXPLANATION OF THE DRAWINGS

As a complement to the present description, and for the purpose of helping to make the characteristics of the invention more readily understandable, in accordance with a preferred practical exemplary embodiment thereof, said description is accompanied by a set of drawings constituting an integral part of the same, which by way of illustration and not limitation represent the following.

FIG. 1 shows a schematic perspective view of the mount object of the invention.

FIG. 2 shows a lateral view of the mount.

FIG. 3 shows a rear view of the mount.

FIG. 4 shows the different placement positions of the connection plugs to the power outlet.

FIG. 5 shows a perspective view in which magnetic holding means are observed.

### PREFERRED EMBODIMENT OF THE INVENTION

With reference to the figures, a preferred embodiment of the invention proposed is described below.

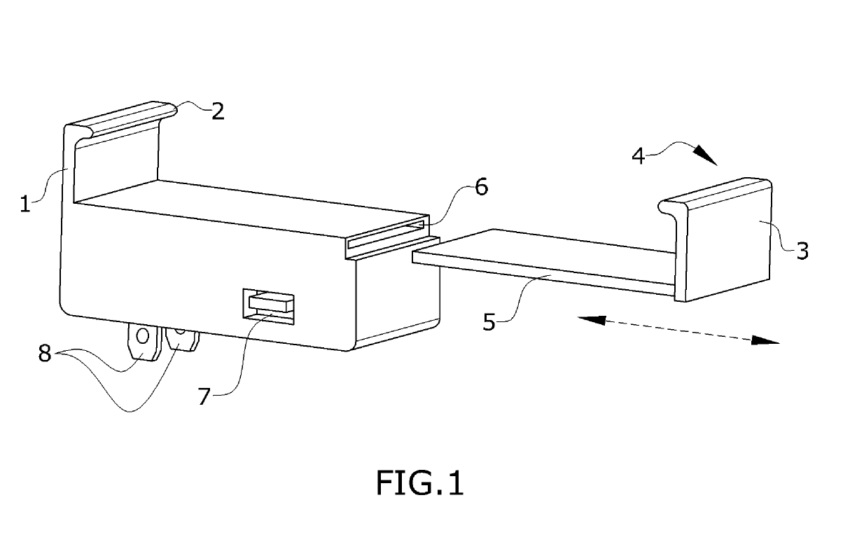

FIG. 1 shows how the wall mount for cell phones has a general U-shaped configuration comprising a first arm (1) and a second arm (3) facing each other, wherein the free end of the first arm (1) and the free end of the second arm (3) each has a projection (2) and (4) respectively turned towards the inner space defined by the two arms (1) and (2) facing each other, wherein the second arm (3) is also an arm that can be unfolded or detached at a distance thereof with respect to the first arm, such that said second arm (2) has a retractable horizontal latch (5) in the inner space of the mount through a slot (6), being able to select the position in which said second arm (2) is to be left at a distance thereof with respect to the first arm (1).

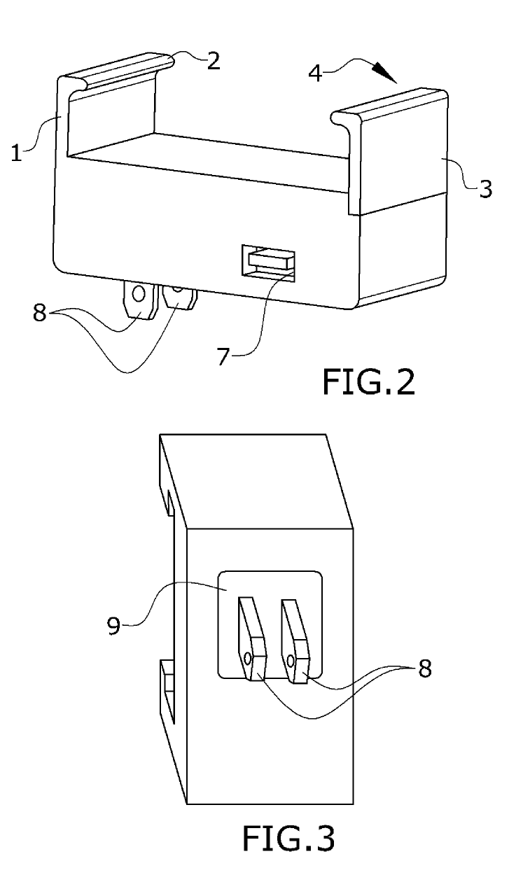

FIG. 2 shows how the wall mount, on one of the side faces thereof, has a USB outlet (7) that makes it possible to connect a USB connector in order to recharge the cell phone.

FIG. 3 shows the rear face of the mount that has connection plugs (8) to the power outlet, said plugs (8) being placed on a rotatable mount (9) with respect to the rest of the mount and which makes it possible to be able to select the orientation of the plugs.

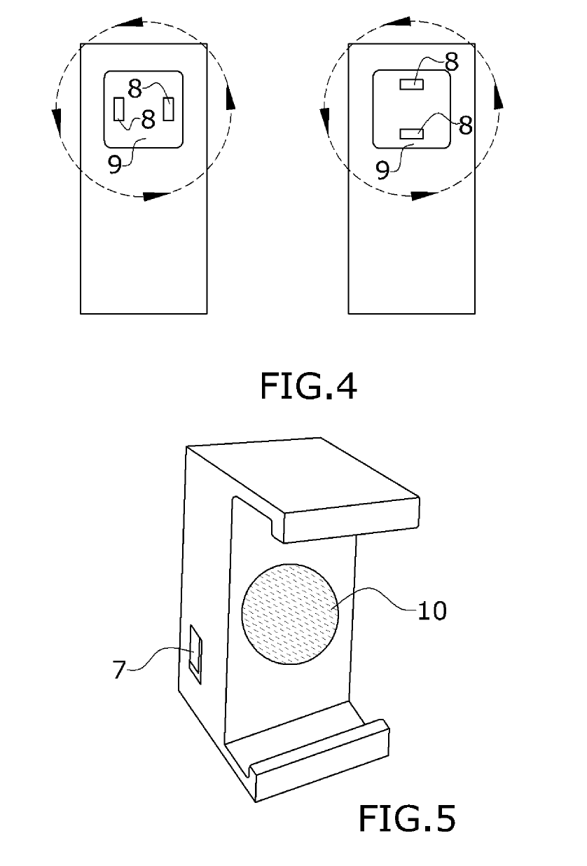

FIG. 4 shows two different positions of the rotatable mount (9) that makes the plugs have a specific orientation and makes it possible to select the most convenient one for the final orientation that the cell phone is to have once held by the mount.

FIG. 5 shows magnetic means (10) integrated into the structure of the mount, preferably in the space comprised between the two arms (1) and (3), the purpose of which is for said magnetic means (10) to ensure the hold of the cell phone.

Having thus adequately described the nature of the present invention, as well as how to put it into practice, it must be noted that, within its essential nature, the invention may be carried out according to other embodiments differing in detail from that set out by way of example, which the protection sought would equally cover, provided that the fundamental principle thereof is not altered, changed or modified.

1. A wall mount for charging cell phones characterized in that it has a general U-shaped configuration comprising a first arm and a second arm facing each other, wherein the free end of the first arm and the free end of the second arm each has a projection respectively turned towards the inner space defined by the two arms facing each other, wherein the second arm is also an arm that can be unfolded or detached at a distance thereof with respect to the first arm, said second arm having a retractable horizontal latch in the inner space of the mount through a slot, being able to select the position in which said second arm is to be left at a distance thereof with respect to the first arm, wherein there are also connection plugs to a power outlet in the rear face of the wall mount, said plugs being placed on a rotatable mount with respect to the rest of the mount.

2. The wall mount for charging cell phones according to claim 1, characterized in that the mount, on one of the side faces thereof, has a USB outlet that makes it possible to connect a USB connector in order to recharge the cell phone.

3. The wall mount for charging cell phones according to claim 1, characterized in that the wall mount comprises magnetic means integrated into the structure of the mount in the space comprised between the two arms.
